(19) United States
(12) Patent Application Publication
(10) Pub. No.: US 2026/0092946 A1
(43) Pub. Date: Apr. 2, 2026

(54) Impact Logger

(71) Applicant: SEIKO EPSON CORPORATION, Tokyo (JP)

(72) Inventors: Ryuta NISHIZAWA, Nagano (JP); Manabu KONDO, Matsumoto (JP); Takeru SAKAIDE, Minowa (JP); Yasuhiro SUDO, Chino (JP); Sanshiro TAKESHITA, Shiojiri (JP)

(21) Appl. No.: 19/341,169

(22) Filed: Sep. 26, 2025

(30) Foreign Application Priority Data
Sep. 27, 2024 (JP) 2024-169415

(51) Int. Cl. G01P 15/125; G01P 15/18

(52) U.S. Cl. CPC G01P 15/125; G01P 15/18

(57) ABSTRACT

An impact logger includes an acceleration sensor, a circuit element including a clocking circuit that generates time data, a sensor circuit that processes an output signal of the acceleration sensor, and a memory circuit that stores processing data processed by the sensor circuit and the time data in association with each other, and a package that accommodates the acceleration sensor and the circuit element, and the impact logger has a mass of less than 20 g. When a mass of an impact measurement target is m1 and the mass is m2, a relationship of m2≤( 1/50)×m1 is satisfied.

The present application is based on, and claims priority from JP Application Serial Number 2024-169415, filed Sep. 27, 2024, the disclosure of which is hereby incorporated by reference herein in its entirety.

### BACKGROUND

### 1. Technical Field

The present disclosure relates to an impact logger.

### 2. Related Art

JP-A-2019-152563 describes an impact detection device capable of detecting an impact or the like applied to a transported article. The impact detection device has a configuration in which an acceleration sensor, a real-time clock, an operation switch, a light emitting diode (LED), a storage unit, a wireless communication unit, a control unit, and a battery are accommodated in a housing made of a translucent or transparent resin.

However, there is no description in JP-A-2019-152563 regarding the mass of the impact detection device.

When the mass of the impact detection device is not sufficiently light with respect to the transported article, the impact detection result of the impact detection device may be affected. Therefore, an error may occur between the actual impact applied to the transported article and the impact detected by the impact detection device, and the detection accuracy of the impact may decrease.

### SUMMARY

An impact logger according to the present disclosure includes an acceleration sensor, a circuit element including a clocking circuit that generates time data, a sensor circuit that processes an output signal of the acceleration sensor, and a memory circuit that stores processing data processed by the sensor circuit and the time data in association with each other, and a package that accommodates the acceleration sensor and the circuit element, and the impact logger has a mass of less than 20 g.

### BRIEF DESCRIPTION OF THE DRAWINGS

FIG. 1 is a top view of an impact logger according to a first embodiment.

FIG. 2 is a sectional view taken along line II-II in FIG. 1.

FIG. 3 is an exploded perspective view illustrating arrangement of each portion in a recessed portion.

FIG. 4 is a top view of a vibration element.

FIG. 5 is a top view of an acceleration sensor.

FIG. 6 is a block diagram illustrating a circuit included in a circuit element.

FIG. 7 is a table illustrating an example of event data.

FIG. 8 is a top view of an impact logger according to a second embodiment.

FIG. 9 is a sectional view taken along line IX-IX in FIG. 8.

FIG. 10 is a sectional view of an impact logger according to a third embodiment.

FIG. 11 is a top view of an impact logger according to a fourth embodiment.

FIG. 12 is a sectional view taken along line XII-XII in FIG. 11.

FIG. 13 is a top view of an impact logger according to a fifth embodiment.

FIG. 14 is a top view of an impact logger according to a sixth embodiment.

FIG. 15 is a sectional view of an impact logger according to a seventh embodiment.

### DESCRIPTION OF EMBODIMENTS

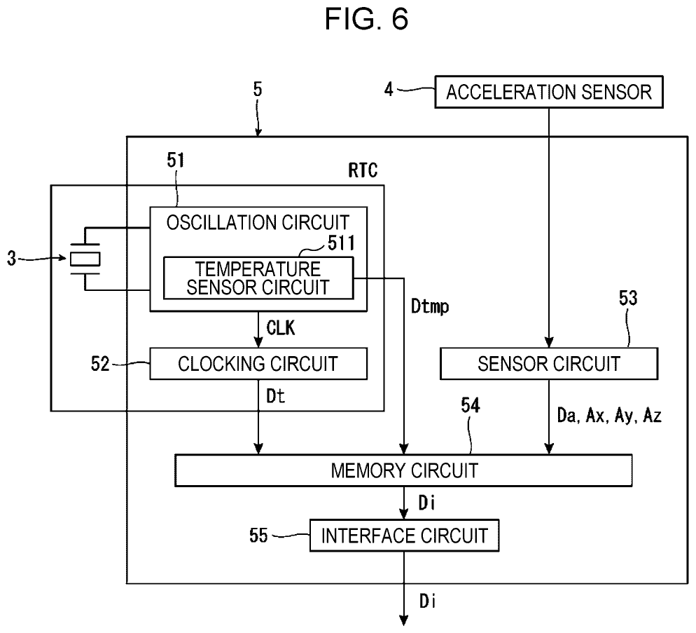

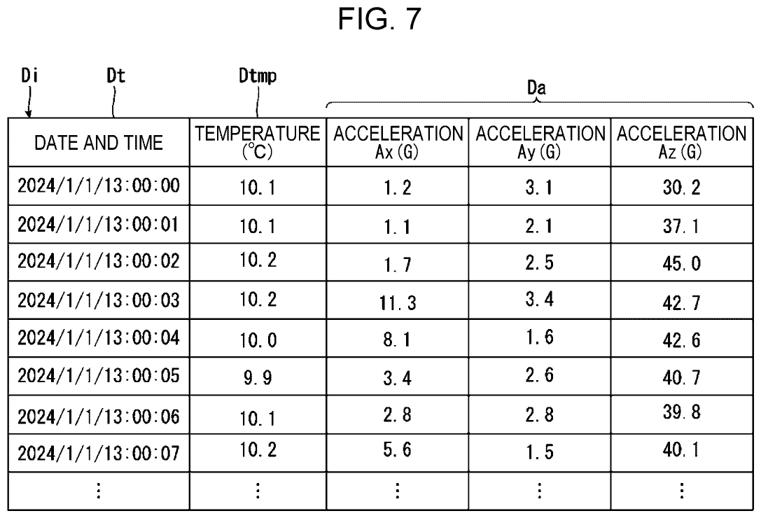

Hereinafter, an impact logger of the present disclosure will be described in detail based on embodiments illustrated in the accompanying drawings. For convenience of description, three axes orthogonal to each other are illustrated as an X-axis, a Y-axis, and a Z-axis in each drawing except FIGS. 6 and 7. A direction along the X-axis is also referred to as an “X-axis direction”, a direction along the Y-axis is also referred to as a “Y-axis direction”, and a direction along the Z-axis is also referred to as a “Z-axis direction”. The arrow side of each axis is also referred to as a “plus side”, and the opposite side is also referred to as a “minus side”. The Z-axis extends in a vertical direction, the arrow side is also referred to as “up”, and the opposite side is also referred to as “down”.

### First Embodiment

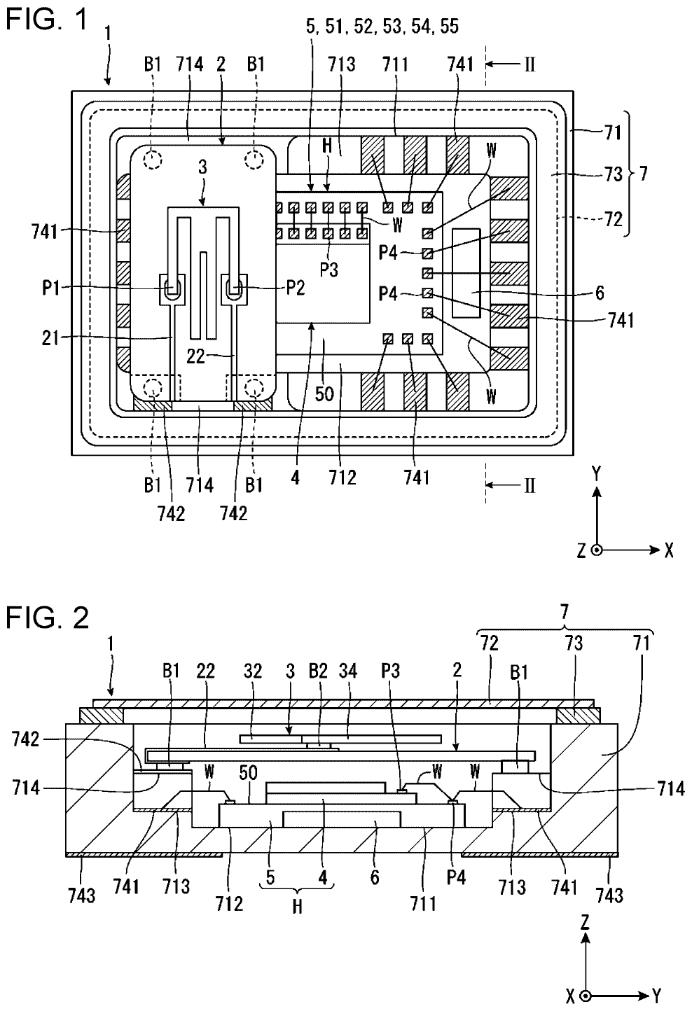

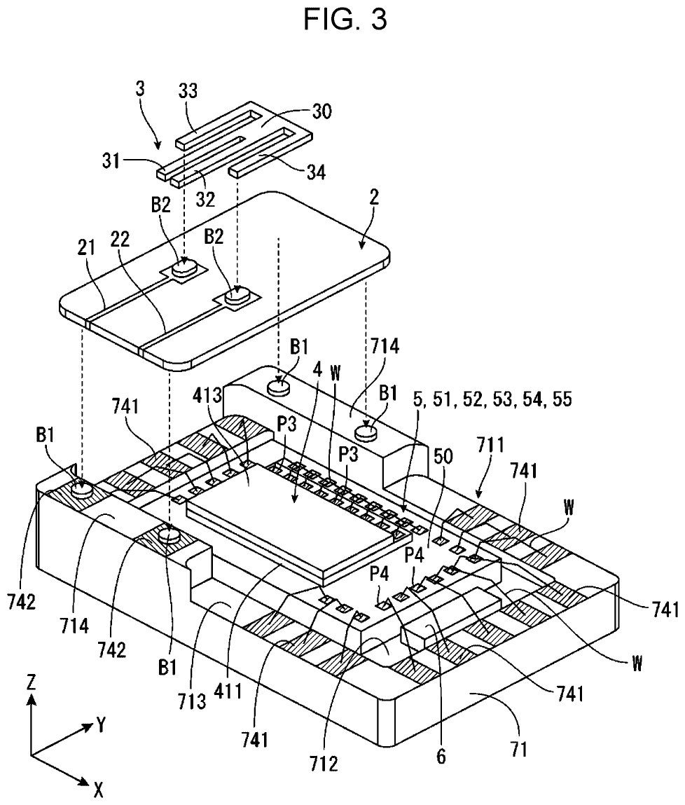

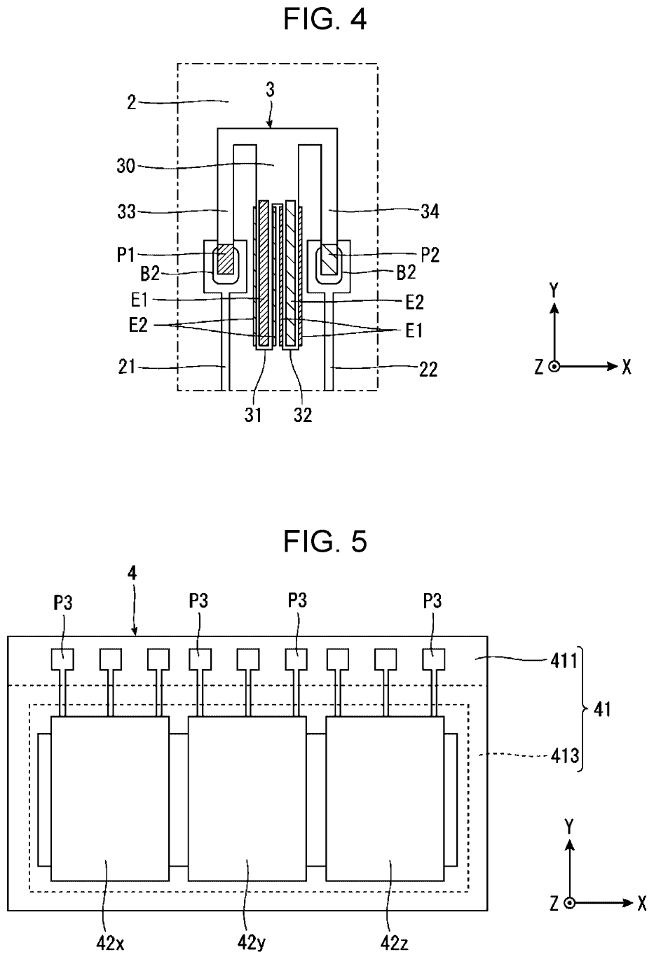

FIG. 1 is a top view of an impact logger according to a first embodiment. FIG. 2 is a sectional view taken along line II-II in FIG. 1. FIG. 3 is an exploded perspective view illustrating arrangement of each portion in a recessed portion. FIG. 4 is a top view of a vibration element. FIG. 5 is a top view of an acceleration sensor. FIG. 6 is a block diagram illustrating a circuit included in a circuit element. FIG. 7 is a table illustrating an example of event data.

An impact logger 1 illustrated in FIG. 1 is mounted on a product which is an impact measurement target and is being transported, detects an impact or the like applied to the product, and stores the detected impact together with an occurrence time. According to such an impact logger 1, it is possible to confirm when and how much impact is applied to a product being transported.

Therefore, for example, when the product is damaged, broken, or the like during transportation, the transportation requester (here, for convenience of description, the manufacturer of the product) who has requested the transportation of the product can clarify the date and time when the damage, breakage, or the like has occurred, the cause of the damage, breakage, or the like, who is responsible, and the like, and can easily respond to the transporter thereafter. By confirming the impact applied to the product during transportation, the mechanical design of the product can be reviewed, and the product can be improved to a product which is less likely to be broken. The shape and size of a cushioning material for protecting the product from impact can also be reviewed. For example, if the size of the cushioning material can be reduced as a result of the review, the product cost and the transportation cost can be reduced accordingly.

On the other hand, from the viewpoint of the transporter who transports the product, the impact logger 1 can be effectively used to prove that the transporter is not the cause of the damage, breakage, or the like. The impact logger 1 proves that the impact applied during the transportation is much smaller than those of other transporters, and for this reason, the high transportation quality is appealed, so that the transporter can be differentiated from other transporters.

As described above, the impact logger 1 provides various advantages to both the transportation requester side and the transporter side. In particular, the impact logger 1 of the present embodiment is inexpensive and compact compared to impact loggers in the related art (for example, the impact detection device described in JP-A-2019-152563), and there is almost no increase in cost or size due to mounting the impact logger 1. Therefore, the impact logger 1 is very convenient.

As illustrated in FIG. 1, the impact logger 1 includes a support substrate 2, a vibration element 3, an acceleration sensor 4, a circuit element 5, a battery 6, and a package 7 that accommodates these components. The impact logger 1 described above is mounted on a product such that the plus side in the Z-axis direction faces up in the vertical direction during transportation, for example.

### Package 7

First, the package 7 will be described. As illustrated in FIG. 1 to FIG. 3, the package 7 includes a cavity-shaped base 71 having a recessed portion 711 that opens to an upper surface and a plate-shaped lid 72 that is bonded to the upper surface of the base 71 via a seam ring 73 and closes the opening of the recessed portion 711. According to such a configuration, the configuration of the package 7 is simplified. In addition, the package 7 has an internal space, and the support substrate 2, the vibration element 3, the acceleration sensor 4, the circuit element 5, and the battery 6 are accommodated in the internal space. The internal space is hermetically sealed and is in a reduced pressure state, preferably a state closer to vacuum. As a result, the viscous resistance of the internal space is reduced, and it is possible to efficiently oscillate the vibration element 3. However, the atmosphere of the internal space is not particularly limited.

The constituent material of the base 71 is not particularly limited. For example, various ceramics such as aluminum oxide can be used. The constituent material of the lid 72 is not particularly limited, but a material with a linear expansion coefficient similar to that of the constituent material of the base 71 is preferable. For example, when the constituent material of the base 71 is a ceramic, an alloy such as Kovar is preferably used. According to such a configuration, the package 7 becomes hard, and the mechanical strength of the impact logger 1 increases. In addition, as will be described later, since each portion can be electrically connected by an internal wiring line (not illustrated) formed in the base 71, a wiring substrate or the like for performing electrical connection is not necessary. Therefore, the impact logger 1 can be reduced in weight and size. According to such a configuration, it becomes easy to increase the inherent vibration frequency of the impact logger 1, and the inherent vibration frequency of the impact logger 1 can be made sufficiently higher than the frequency of the vibration of the impact generated during transportation. Therefore, it is possible to effectively suppress the resonance of the impact logger 1 due to the impact generated during transportation, and it is possible to detect the impact generated during transportation with high accuracy.

As illustrated in FIG. 2, the base 71 includes a bottom surface 712 of the recessed portion 711, a first stepped surface 713 that is located above the bottom surface 712 (on the plus side in the Z-axis direction) and parallel to the bottom surface 712, and a second stepped surface 714 that is located above the first stepped surface 713 (on the plus side in the Z-axis direction) and parallel to the bottom surface 712. As illustrated in FIG. 1, the first stepped surface 713 has a frame shape surrounding a periphery of the bottom surface 712 in plan view in the Z-axis direction. In addition, in plan view in the Z-axis direction, the second stepped surface 714 is disposed to be divided into two so as to face each other in the Y-axis direction with the bottom surface 712 interposed therebetween. In addition, the second stepped surface 714 is disposed to be biased to the minus side in the X-axis direction. The circuit element 5 and the battery 6 are disposed side by side in the X-axis direction on the bottom surface 712, the acceleration sensor 4 is disposed on an upper surface of the circuit element 5, the support substrate 2 is disposed on the second stepped surface 714, and the vibration element 3 is disposed on an upper surface of the support substrate 2. However, the shapes of the first and second stepped surfaces 713 and 714 are not particularly limited.

As illustrated in FIG. 1, a plurality of first internal terminals 741 is disposed on the first stepped surface 713, and a plurality of second internal terminals 742 is disposed on the second stepped surface 714. As illustrated in FIG. 2, a plurality of external terminals 743 is disposed on a lower surface of the base 71. Each of the plurality of the first internal terminals 741 is electrically connected to a predetermined second internal terminal 742 or a predetermined external terminal 743 via an internal wiring line (not illustrated) formed in the base 71. The respective first internal terminals 741 are electrically connected to the circuit element 5 via conductive wires W (bonding wires), and the respective second internal terminals 742 are electrically connected to the vibration element 3 via conductive bonding members B1 and later-described wiring lines 21 and 22 formed on the support substrate 2. The number and arrangement of the first and second internal terminals 741 and 742 and the external terminal 743 are not particularly limited, and may be appropriately set in accordance with, for example, the number of terminals of the circuit element 5 and the vibration element 3.

The size of the package 7 is not particularly limited. For example, the length in the X-axis direction×the length in the Y-axis direction is preferably 10 mm or less×10 mm or less. As a result, the impact logger 1 can be made sufficiently compact. In the present embodiment, the size is approximately 7 mm×approximately 5 mm.

### Vibration Element 3

As illustrated in FIG. 4, the vibration element 3 is a tuning fork type quartz crystal vibrator. The vibration element 3 is obtained by patterning a Z cut quartz crystal substrate into a predetermined outer shape by etching or the like and includes a base portion 30, a pair of vibrating arms 31 and 32 extending from the base portion 30 to the minus side in the Y-axis direction, and a pair of L-shaped support arms 33 and 34 extending from the base portion 30. The vibration element 3 is bonded to the upper surface of the support substrate 2 via conductive bonding members B2 at tip end portions of the support arms 33 and 34. The vibration element 3 includes first excitation electrodes E1 disposed on upper and lower surfaces of the vibrating arm 31 and both side surfaces of the vibrating arm 32 and second excitation electrodes E2 disposed on both side surfaces of the vibrating arm 31 and upper and lower surfaces of the vibrating arm 32. The first excitation electrodes E1 are electrically connected to a first connection terminal P1 disposed at the tip end portion of the support arm 33 via wiring lines (not illustrated), and the second excitation electrodes E2 are electrically connected to a second connection terminal P2 disposed at the tip end portion of the support arm 34 via wiring lines (not illustrated). In the vibration element 3 described above, when a drive signal (alternating voltage) is applied between the first and second excitation electrodes E1 and E2 via the first and second connection terminals P1 and P2, the vibrating arms 31 and 32 repeat approaching and separating from each other to perform in-plane vibration.

Although the vibration element 3 has been described above, the configuration of the vibration element 3 is not particularly limited. For example, a configuration using a quartz crystal substrate cut at a cut angle other than Z cut, such as AT cut or SC cut, may be employed.

### Support Substrate 2

As illustrated in FIG. 1, the support substrate 2 has a substantially rectangular plate shape having a thickness in the Z-axis direction and is bonded to the second stepped surface 714 via the conductive bonding members B1 at an outer edge portion of the support substrate 2. The support substrate 2 is located below the vibration element 3 and supports the vibration element 3 from below at a center portion thereof. The support substrate 2 described above has a function of absorbing or alleviating stress generated by deformation of the base 71 and thermal stress generated by a difference in linear expansion coefficient and making it difficult for the stress to be transmitted to the vibration element 3, in addition to a function of electrically relaying the vibration element 3 and the base 71.

The support substrate 2 described above is formed of a quartz crystal substrate, similarly to the vibration element 3. As a result, the support substrate 2 having high mechanical strength is obtained. By configuring the support substrate 2 with the same quartz crystal substrate as the vibration element 3, it is possible to make the linear expansion coefficients of the support substrate 2 and the vibration element 3 substantially equal to each other. Therefore, thermal stress caused by the difference in linear expansion coefficient is not substantially generated between the support substrate 2 and the vibration element 3, and the vibration element 3 is less likely to receive stress. Therefore, driving of the vibration element 3 is further stabilized. In particular, the support substrate 2 is formed of the same Z cut quartz crystal substrate as the vibration element 3. The direction of the crystal axis also coincides with that of the vibration element 3. The quartz crystal has different linear expansion coefficients in the X-axis (electrical axis) direction, the Y-axis (mechanical axis) direction, and the Z-axis (optical axis) direction. Therefore, by setting the support substrate 2 and the vibration element 3 to have the same cut angle and further aligning the directions of the crystal axes of the support substrate 2 and the vibration element 3, the thermal stress described above is less likely to be generated between the support substrate 2 and the vibration element 3. Therefore, the vibration element 3 is less likely to receive the stress, and the driving of the vibration element 3 is further stabilized.

The support substrate 2 is not limited thereto and is formed of, for example, a quartz crystal substrate having the same cut angle as the vibration element 3, but the direction of the crystal axis may be different from that of the vibration element 3. The support substrate 2 may be formed of a quartz crystal substrate having a cut angle different from that of the vibration element 3. The support substrate 2 does not have to be formed from a quartz crystal substrate and can be formed from, for example, a silicon substrate or a resin substrate. In addition, for example, a substrate for tape automated bonding (TAB) mounting including a support substrate and a lead extending from the support substrate may be used.

The two wiring lines 21 and 22 for electrically connecting the first and second connection terminals P1 and P2 included in the vibration element 3 to the second internal terminals 742 disposed on the second stepped surface 714 of the base 71 are disposed on the support substrate 2. One end portions of the wiring lines 21 and 22 are electrically connected to the second internal terminals 742 via the conductive bonding members B1, and the other end portions of the wiring lines 21 and 22 are electrically connected to the first and second connection terminals P1 and P2 via the conductive bonding members B2. The bonding members B1 and B2 are not particularly limited as long as the bonding members B1 and B2 have both conductivity and a bonding property. For example, a conductive adhesive in which a conductive filler such as a silver filler is dispersed in various metal bumps such as gold bumps, silver bumps, copper bumps, and solder bumps, or polyimide-based, epoxy-based, silicone-based, or acrylic adhesives can be used.

### Acceleration Sensor 4

The acceleration sensor 4 is a three-axis acceleration sensor capable of detecting an acceleration Ax in the X-axis direction, an acceleration Ay in the Y-axis direction, and an acceleration Az in the Z-axis direction.

The acceleration sensor 4 is a silicon micro electro mechanical systems (MEMS). Therefore, the acceleration sensor 4 can be reduced in size.

As illustrated in FIG. 5, the acceleration sensor 4 includes a package 41, and an X-axis acceleration sensor element 42x, a Y-axis acceleration sensor element 42y, and a Z-axis acceleration sensor element 42z that are accommodated in the package 41. The package 41 includes a base 411 that supports the sensor elements 42x, 42y, and 42z, and a lid 413 that is bonded to an upper surface of the base 411 and accommodates the sensor elements 42x, 42y, and 42z between the lid 413 and the base 411. The base 411 is larger than the lid 413, and a portion (an end portion on the plus side in the Y-axis direction) of the upper surface of the base 411 is exposed to the outside from the lid 413. A plurality of connection terminals P3 electrically connected to the sensor elements 42x, 42y, and 42z is disposed in the portion of the upper surface of the base 411 exposed from the lid 413.

The acceleration sensor 4 described above can be formed by, for example, a process of forming the base 411 from one silicon layer (handle layer) of a silicon-on-insulator (SOI) substrate and forming the sensor elements 42x, 42y, and 42z from the other silicon layer (device layer) and a process of bonding the lid 413 formed from a silicon substrate to the base 411. According to such a configuration, the acceleration sensor 4 can be manufactured by a manufacturing method based on a silicon semiconductor process.

Hereinafter, the X-axis acceleration sensor element 42x, the Y-axis acceleration sensor element 42y, and the Z-axis acceleration sensor element 42z will be briefly described.

The X-axis acceleration sensor element 42X includes a fixed inter digital transducer fixed to the base 411 and a movable inter digital transducer disposed so as to mesh with the fixed inter digital transducer and displaceable in the X-axis direction with respect to the base 411, and the fixed inter digital transducer and the movable inter digital transducer are disposed so as to face each other in the X-axis direction. When the acceleration Ax in the X-axis direction is applied to the X-axis acceleration sensor element 42x, the movable inter digital transducer is displaced in the X-axis direction, and the capacitance between the fixed inter digital transducer and the movable inter digital transducer changes in accordance with the displacement. Therefore, the change in the capacitance can be taken out from the connection terminals P3 as an output signal, and the acceleration Ax can be detected based on the output signal. However, the configuration of the X-axis acceleration sensor element 42x is not particularly limited as long as the acceleration Ax can be detected.

The Y-axis acceleration sensor element 42y has a configuration in which the X-axis acceleration sensor element 42x is rotated by 90° around the Z-axis. That is, the Y-axis acceleration sensor element 42y has a fixed inter digital transducer fixed to the base 411 and a movable inter digital transducer disposed so as to mesh with the fixed inter digital transducer and displaceable in the Y-axis direction with respect to the base 411, and the fixed inter digital transducer and the movable inter digital transducer are disposed so as to face each other in the Y-axis direction. When the acceleration Ay in the Y-axis direction is applied to the Y-axis acceleration sensor element 42y, the movable inter digital transducer is displaced in the Y-axis direction, and the capacitance between the fixed inter digital transducer and the movable inter digital transducer changes in accordance with the displacement. Therefore, the change in the capacitance can be taken out from the connection terminals P3 as an output signal, and the acceleration Ay can be detected based on the output signal. However, the configuration of the Y-axis acceleration sensor element 42y is not particularly limited as long as the acceleration Ay can be detected.

The Z-axis acceleration sensor element 42z includes a fixed inter digital transducer fixed to the base 411 and a movable inter digital transducer disposed so as to mesh with the fixed inter digital transducer and displaceable in the Z-axis direction with respect to the base 411. When the acceleration Az in the Z-axis direction is applied to the Z-axis acceleration sensor element 42z, the movable inter digital transducer is displaced in the Z-axis direction, and the capacitance between the fixed inter digital transducer and the movable inter digital transducer changes in accordance with the displacement. Therefore, the change in the capacitance can be taken out from the connection terminals P3 as an output signal, and the acceleration Az can be detected based on the output signal. However, the configuration of the Z-axis acceleration sensor element 42z is not particularly limited as long as the acceleration Az can be detected.

As illustrated in FIGS. 1 to 3, the acceleration sensor 4 having such a configuration is bonded to the upper surface of the circuit element 5 via a bonding member (not illustrated). The respective connection terminals P3 are electrically connected to the circuit element 5 via the conductive wires W (bonding wires).

The acceleration sensor 4 has been described above, but the configuration of the acceleration sensor 4 is not particularly limited. For example, the base 411 and the lid 413 may be formed of a material other than silicon, such as a glass material. In addition, the package 41 may be divided for each of the sensor elements 42x, 42y, and 42z. In this case, for example, the sensor elements 42x, 42y, and 42z may be disposed to overlap with each other in the Z-axis direction. In addition, two or more sensor elements selected from the sensor elements 42x, 42y, and 42z may be integrally formed as one sensor element. In other words, a configuration in which two or more of the accelerations Ax, Ay, and Az can be detected by one sensor element may be adopted. The acceleration sensor 4 is not limited to a three-axis acceleration sensor having three acceleration detection axes and may have a configuration having two acceleration detection axes or a configuration having one acceleration detection axis. In this case, it is preferable that at least the Z-axis acceleration sensor element 42z is provided and the acceleration Az in the Z-axis direction can be detected. As a result, it is possible to more reliably detect an impact in the vertical direction, which is most likely to occur during transportation and is likely to cause breakage or the like. The acceleration sensor 4 does not have to include the package 41, and the sensor elements 42x, 42y, and 42z may be exposed to the internal space of the package 7. According to such a configuration, the impact logger 1 can be further reduced in size.

### Circuit Element 5

As illustrated in FIGS. 1 to 3, the circuit element 5 is bonded to the bottom surface 712 of the recessed portion 711 via a bonding member (not illustrated). The circuit element 5 is composed of one chip. By composing the circuit element 5 of one chip in this manner, the circuit element 5 can be reduced in size, for example, compared to a case where the circuit element 5 is composed of a plurality of chips as in an embodiment described later. Therefore, the impact logger 1 can be reduced in size. Since the inherent vibration frequency of the impact logger 1 can be further increased by reducing the impact logger 1 in size, the resonance with the impact during transportation can be further effectively suppressed, and the impact can be detected with higher accuracy.

The circuit element 5 is disposed in an orientation in which an active surface 50 on which a plurality of connection terminals P4 is formed faces upward (the plus side in the Z-axis direction), and the acceleration sensor 4 is disposed on the active surface 50. That is, the circuit element 5 and the acceleration sensor 4 are stacked on the base 71. In addition, some of the plurality of connection terminals P4 are electrically connected to the first internal terminals 741 disposed on the first stepped surface 713 of the base 71 via the wires W, and the remaining connection terminals P4 are electrically connected to the acceleration sensor 4 via the wires W. Hereinafter, a stacked body of the circuit element 5 and the acceleration sensor 4 is also referred to as a stacked body H.

In this manner, by disposing the circuit element 5 on the bottom surface 712 and disposing the acceleration sensor 4 on the upper surface of the circuit element 5, it is possible to secure a large area in which the circuit element 5 can be disposed, and it is possible to mount the circuit element 5 that is larger. Therefore, the circuit element 5 having higher performance can be mounted, or the circuit element 5 having more functions can be mounted. In particular, in a case where the programmable circuit element 5 whose function can be freely customized by the user is mounted, the size of the circuit element 5 is likely to increase, and thus the configuration of the present embodiment is effective.

The circuit element 5 described above is, for example, a micro controller unit (MCU) and integrally controls each portion of the impact logger 1. As illustrated in FIG. 6, the circuit element 5 includes a temperature compensated oscillation circuit 51 for oscillating the vibration element 3, a clocking circuit 52 for generating time data Dt, a sensor circuit 53 for processing the output signal of the acceleration sensor 4 to obtain the accelerations Ax, Ay, and Az, a memory circuit 54 for storing processing data Da including the accelerations Ax, Ay, and Az obtained by the sensor circuit 53 in association with the time data Dt as event data Di, an interface circuit 55 for communicating with the outside, and a control circuit (not illustrated) for controlling the circuits 51 to 55.

The temperature compensated oscillation circuit 51 includes a temperature sensor circuit 511 that detects the temperature of the vibration element 3. The temperature sensor circuit 511 is not particularly limited, but is, for example, a circuit including a negative temperature coefficient (NTC) thermistor that is a resistor of which the resistance value changes according to the temperature and is a circuit that detects the temperature of the vibration element 3 using the change in the resistance value. The oscillation circuit 51 is electrically connected to the vibration element 3, amplifies the output signal of the vibration element 3, and feeds back the amplified signal to the vibration element 3, thereby oscillating the vibration element 3 to generate a clock signal CLK. The frequency of the clock signal CLK is, for example, 32.768 kHz. The oscillation circuit 51 compensates for the frequency-temperature characteristics of the clock signal CLK based on the temperature of the vibration element 3 detected by the temperature sensor circuit 511. That is, temperature compensation is performed such that the frequency variation of the clock signal CLK is smaller than the frequency-temperature characteristics of the vibration element 3. According to such a configuration, the frequency variation of the clock signal CLK due to the temperature change can be suppressed, and the highly accurate clock signal CLK can be generated.

As the oscillation circuit 51, for example, an oscillation circuit such as a Pierce oscillation circuit, an inverter-type oscillation circuit, a Colpitts oscillation circuit, or a Hartley oscillation circuit can be used. The temperature compensation may be, for example, adjustment of the frequency of the clock signal CLK by adjusting the capacitance of a variable capacitance circuit connected to the oscillation circuit 51, or adjustment of the frequency of the clock signal CLK generated by the oscillation circuit 51 by a phase locked loop (PLL) circuit or a direct digital synthesizer circuit.

The clock signal CLK generated by the oscillation circuit 51 is divided in frequency by a frequency dividing circuit (not illustrated) and then input to the clocking circuit 52. For example, the frequency division ratio of the frequency dividing circuit is 32, and the clock signal CLK that is divided in frequency has a frequency of 1.024 kHz. The clocking circuit 52 performs clocking based on the clock signal CLK and generates the time data Dt. The time data Dt includes seconds, minutes, hours, days, months, and years as time digits. That is, in the impact logger 1, the oscillation circuit 51 oscillates the vibration element 3 to generate the clock signal CLK, and the clocking circuit 52 performs clocking based on the clock signal CLK to generate the time data Dt, thereby configuring a real-time clock RTC. According to such a configuration, it is possible to generate the highly accurate time data Dt.

The sensor circuit 53 controls driving of the acceleration sensor 4 and obtains the accelerations Ax, Ay, and Az based on the output signals of the X-axis, Y-axis, and Z-axis acceleration elements 42x, 42y, and 42z, respectively. Then, the accelerations Ax, Ay, and Az are output as processing data Da.

For example, as illustrated in FIG. 7, the memory circuit 54 stores the processing data Da (the accelerations Ax, Ay, and Az) output from the sensor circuit 53 and temperature data Dtmp detected by the temperature sensor circuit 511 as the event data Di associated with the time data Dt generated by the clocking circuit 52. That is, the memory circuit 54 generates and stores the event data Di in which the current time, the impact generated at that time, and the temperature at that time are associated with each other for each measurement cycle. Therefore, it is possible to easily confirm the history of the impact received during transportation based on the event data Di. In particular, since the event data Di includes the temperature data Dtmp, the impact logger 1 has a large amount of information.

According to such a configuration, in addition to identification of the cause of breakage or the like based on an impact during transportation, for example, it is possible to easily confirm whether or not a product (in particular, a product requiring refrigeration or freezing) is constantly maintained in an appropriate temperature range during the transportation based on the temperature data Dtmp. In addition, it is possible to identify breakage due to exposure to an excessively high temperature or low temperature during transportation, or breakage due to dew condensation caused by a rapid temperature change during transportation. For example, the memory circuit 54 does not have to store the event data Di for the entire measurement cycle and may store the event data Di only when the accelerations Ax, Ay, and Az equal to or greater than a preset threshold value are detected. According to such a configuration, the capacity of the memory circuit 54 can be reduced.

The interface circuit 55 transmits and receives signals, receives an input (command) from the outside, and outputs the event data Di stored in the memory circuit 54. The communication method is not particularly limited, and for example, serial peripheral interface (SPI) communication can be used.

### Battery 6

As illustrated in FIGS. 1 to 3, the battery 6 is bonded to the bottom surface 712 of the recessed portion 711 via a bonding member (not illustrated). The battery 6 is arranged side by side with the circuit element 5 in the X-axis direction. The battery 6 supplies power to the circuit element 5. That is, the circuit element 5 is driven by power supplied from the battery 6. Therefore, the impact logger 1 can operate without external power supply. The battery 6 is not particularly limited, and for example, a solid battery, a coin battery, or the like can also be used.

However, the arrangement of the battery 6 is not particularly limited, and for example, the battery 6 may be disposed on the upper surface of the circuit element 5 together with the acceleration sensor 4, or may be disposed on an upper surface of the acceleration sensor 4.

The configuration of the impact logger 1 has been described above. In the impact logger 1 described above, the vibration element 3, the support substrate 2, the acceleration sensor 4, and the circuit element 5 are arranged in alignment in the Z-axis direction. In plan view in the Z-axis direction, the vibration element 3, the support substrate 2, the acceleration sensor 4, and the circuit element 5 overlap with each other. According to such a configuration, the planar spread of the impact logger 1 in the X-axis direction and the Y-axis direction, that is, the footprint is suppressed, and the impact logger 1 can be reduced in size.

Moreover, a mass m2 of the impact logger 1 is less than 20 g. This makes the impact logger 1 sufficiently light. Therefore, the impact applied to the product (impact measurement target) on which the impact logger 1 is mounted is less likely to be increased or decreased by the spring-mass system formed between the exterior of the product and the impact logger 1, and the impact equivalent to the actual impact applied to the product can be transmitted to the impact logger 1. Therefore, according to the impact logger 1, it is possible to accurately detect the impact applied to the product. In addition, since the impact logger 1 is light, the impact logger 1 can be easily mounted on a lighter product, for example, a light product such as a digital camera, a smartphone, or a tablet terminal, and a wearable terminal such as a smart watch or smart glasses, without reducing the impact detection accuracy.

The mass m2 of the impact logger 1 may be less than 20 g, but is preferably less than 10 g, and more preferably less than 1 g. This makes the impact logger 1 even lighter. Therefore, the impact detection accuracy of the impact logger 1 is further improved. In addition, the impact logger 1 can be mounted on a lighter product.

Here, when a mass of a product (impact measurement target) is m1 and the mass of the impact logger 1 is m2, it is preferable that the impact logger 1 satisfies a relationship of m2≤( 1/50)×m1. That is, the mass m2 of the impact logger 1 is preferably less than 1/50 of the mass m1 of the product. By satisfying such a relationship, the impact logger 1 becomes sufficiently light in mass with respect to the product, the mounting of the impact logger 1 does not substantially affect the resonance frequency of the product, and an impact detection accuracy error of ±1% can be exhibited. That is, the error of the impact detected by the impact logger 1 with respect to the actual impact applied to the impact can be 1% or less. Therefore, the impact logger 1 having more excellent impact detection accuracy is obtained.

Briefly, a resonance frequency f is expressed by f=[1/(2π)]×√(k/m1). Here, k is a spring constant, and m1 is the mass of the product. In the present embodiment, when the impact logger 1 is mounted on the product, f=[1/(2π)]×√[k/(m1+m2)]. In order to secure the detection accuracy error of ±1%, √(k/m1)/√[k/(m1+m2)] needs to be 0.99 or more. Since 0.99=√(1/1.02), if m2≤0.02 is set with respect to m1=1, that is, if m2 is set to 1/50 or less with respect to m1, it can be understood that the detection accuracy error of ±1% can be secured. For this reason, if the mass of the impact logger 1 is less than 20 g, it is possible to secure the detection accuracy error of 1% for a product of 1000 g (20 g×50) or higher. Further, if the mass of the impact logger 1 is less than 10 g, the detection accuracy error of 1% can be secured for a product of 500 g (10 g×50) or higher, and if the mass of the impact logger 1 is less than 1 g, the detection accuracy error of 1% can be secured for a product of 50 g (1 g×50) or higher. Therefore, the impact logger 1 is excellent in impact detection accuracy and can be mounted on a small product.

The impact logger 1 has been described above. As described above, the impact logger 1 described above includes the acceleration sensor 4, the circuit element 5 including the clocking circuit 52 that generates the time data Dt, the sensor circuit 53 that processes an output signal of the acceleration sensor 4, and the memory circuit 54 that stores the processing data Da processed by the sensor circuit 53 and the time data Dt in association with each other, and the package 7 that accommodates the acceleration sensor 4 and the circuit element 5, and the impact logger 1 has a mass of less than 20 g. According to such a configuration, the impact logger 1 becomes sufficiently light. Therefore, the impact applied to the product (impact measurement target) on which the impact logger 1 is mounted is less likely to be increased or decreased by the spring-mass system formed between the exterior of the product and the impact logger 1, and the impact equivalent to the actual impact applied to the product can be transmitted to the impact logger 1. Therefore, according to the impact logger 1, it is possible to accurately detect the impact applied to the product. In addition, since the impact logger 1 is light, the impact logger 1 can be easily mounted on a lighter product, for example, a small product such as a digital camera, a smartphone, or a tablet terminal, and a wearable terminal such as a smart watch, or smart glasses without reducing the impact detection accuracy described above.

As described above, the mass of the impact logger 1 is less than 10 g. According to such a configuration, the impact logger 1 becomes lighter. Therefore, the impact detection accuracy of the impact logger 1 is further improved. In addition, the impact logger 1 can be mounted on a lighter product.

Further, as described above, the mass of the impact logger 1 is less than 1 g. According to such a configuration, the impact logger 1 becomes lighter. Therefore, the impact detection accuracy of the impact logger 1 is further improved. In addition, the impact logger 1 can be mounted on a lighter product.

In addition, as described above, when the mass of the product which is the impact measurement target is m1 and the mass of the impact logger 1 is m2, the relationship of m2≤( 1/50)×m1 is satisfied. According to such a configuration, the impact logger 1 can secure an impact detection error of 1%, is excellent in impact detection accuracy, and can be mounted on a small product.

As described above, the impact logger 1 includes the battery 6 that supplies power to the circuit element 5. According to such a configuration, the impact logger 1 can operate without power supply from the outside.

As described above, the impact logger 1 includes the vibration element 3 accommodated in the package 7, and the circuit element 5 includes the oscillation circuit 51 that oscillates the vibration element 3. The oscillation circuit 51 oscillates the vibration element 3 to generate the clock signal CLK, and the clocking circuit 52 performs clocking based on the clock signal CLK to generate the time data Dt, thereby configuring the real-time clock RTC. According to such a configuration, it is possible to generate the highly accurate time data Dt.

As described above, the package 7 includes the base 71 on which the acceleration sensor 4 and the circuit element 5 are disposed. The acceleration sensor 4 and the circuit element 5 are disposed on the base 71 in a stacked state. According to such a configuration, the planar spread of the impact logger 1 in the X-axis direction and the Y-axis direction, that is, the footprint is suppressed, and the impact logger 1 can be reduced in size.

As described above, the circuit element 5 is disposed on the base 71, and the acceleration sensor 4 is disposed on the circuit element 5. According to such a configuration, the larger circuit element 5 can be mounted. Therefore, the circuit element 5 having higher performance can be mounted, or the circuit element 5 having more functions can be mounted.

As described above, the package 7 includes the lid 72 that is bonded to the base 71 and accommodates the circuit element 5 and the acceleration sensor 4 between the lid 72 and the base 71. According to such a configuration, the configuration of the package is simplified.

As described above, the circuit element 5 includes the temperature sensor circuit 511 that detects the temperature, and the memory circuit 54 stores the temperature data Dtmp detected by the temperature sensor circuit 511, the processing data Da, and the time data Dt in association with each other. According to such a configuration, since the temperature can be stored together with the impact, the impact logger 1 having a large amount of information can be obtained.

### Second Embodiment

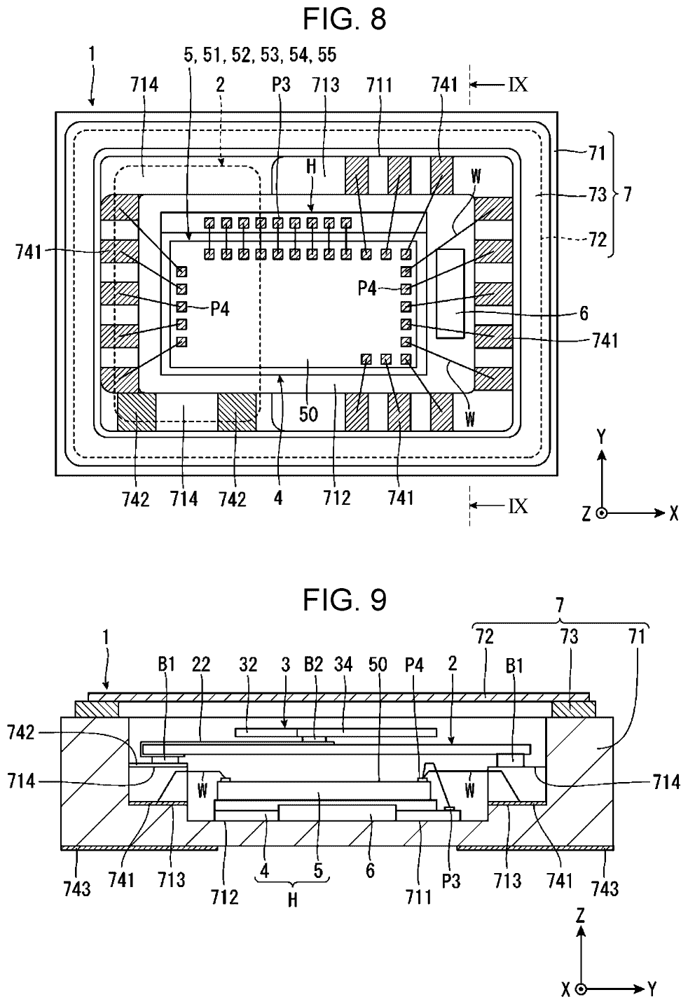

FIG. 8 is a top view of an impact logger according to a second embodiment. FIG. 9 is a sectional view taken along line IX-IX in FIG. 8.

The impact logger 1 of the present embodiment is the same as that of the first embodiment described above except that the configuration of the stacked body H is different. In the following description, the present embodiment will be described with a focus on differences from the first embodiment described above, and the description of the same matters will be omitted. In addition, in each of the drawings of the present embodiment, the same components as those of the embodiment described above are denoted by the same reference numerals.

As illustrated in FIGS. 8 and 9, in the impact logger 1 of the present embodiment, the stacking order of the stacked body H is opposite to that of the first embodiment, the acceleration sensor 4 is disposed on the bottom surface 712 of the recessed portion 711, and the circuit element 5 is disposed on the upper surface of the acceleration sensor 4. That is, the acceleration sensor 4 is disposed on the base 71, and the circuit element 5 is disposed on the acceleration sensor 4. In this manner, by disposing the acceleration sensor 4 below the circuit element 5, it is possible to secure a large area in which the acceleration sensor 4 can be disposed, and it is possible to mount the acceleration sensor 4 that is larger. Therefore, for example, compared to the first embodiment described above, the capacitances formed between the fixed inter digital transducers and the movable inter digital transducers of the sensor elements 42x, 42y, and 42z can be increased, and the accelerations Ax, Ay, and Az can be detected with higher accuracy.

As described above, in the impact logger 1 of the present embodiment, the acceleration sensor 4 is disposed on the base 71, and the circuit element 5 is disposed on the acceleration sensor 4. According to such a configuration, the larger acceleration sensor 4 can be mounted, and the impact (the accelerations Ax, Ay, and Az) can be more accurately detected.

Even in the second embodiment described above, the same effects as those of the first embodiment described above can be exhibited.

### Third Embodiment

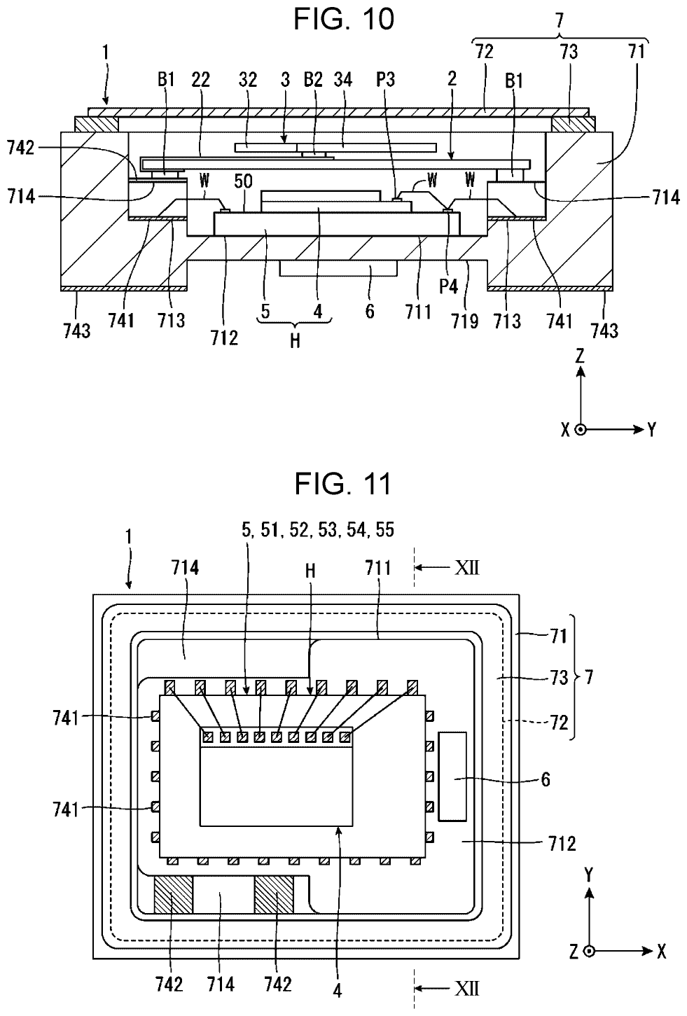

FIG. 10 is a sectional view of an impact logger according to a third embodiment.

The impact logger 1 of the present embodiment is the same as that of the above-described first embodiment except that the configuration of the package 7 and the arrangement of the battery 6 are different. In the following description, the present embodiment will be described with a focus on differences from the first embodiment described above, and the description of the same matters will be omitted. In addition, in each of the drawings of the present embodiment, the same components as those of the embodiments described above are denoted by the same reference numerals.

As illustrated in FIG. 10, in the impact logger 1 of the present embodiment, the base 71 of the package 7 has a recessed portion 719 that opens to the lower surface in addition to the recessed portion 711 that opens to the upper surface. The battery 6 is accommodated in the recessed portion 719 and is disposed on a bottom surface of the recessed portion 719. The battery 6 overlaps with the circuit element 5 in plan view in the Z-axis direction. In this manner, by arranging the battery 6 so as to overlap with the circuit element 5, for example, the planar expansion of the impact logger 1 in the X-axis direction and the Y-axis direction can be further suppressed from the first embodiment described above, and the impact logger 1 can be further reduced in size. In addition, according to such a configuration, since the battery 6 is exposed to the outside of the package 7, the battery 6 can be easily replaced. Therefore, long-term continuous use, reuse, and the like of the impact logger 1 by battery replacement are facilitated.

As described above, in the impact logger 1 of the present embodiment, the battery 6 is exposed to the outside of the package 7. According to such a configuration, replacement of the battery 6 is facilitated, and long-term continuous use, reuse, and the like of the impact logger 1 by battery replacement are facilitated.

Even in the third embodiment described above, the same effects as those of the first embodiment described above can be exhibited.

### Fourth Embodiment

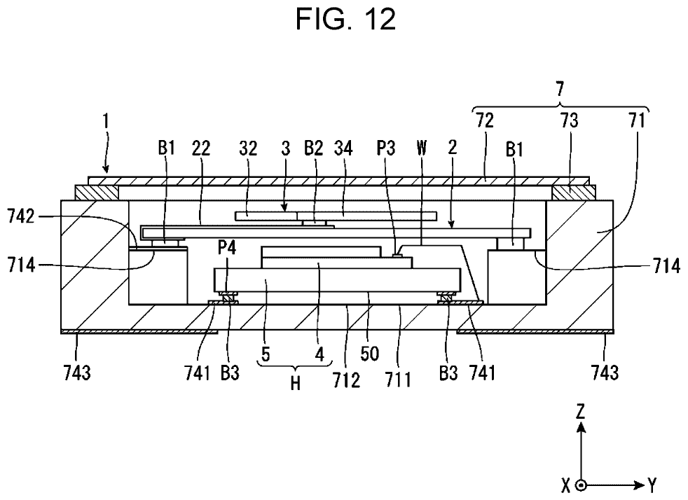

FIG. 11 is a top view of an impact logger according to a fourth embodiment. FIG. 12 is a sectional view taken along line XII-XII in FIG. 11. In FIG. 11, for convenience of description, the support substrate 2 and the vibration element 3 are not illustrated.

The impact logger 1 of the present embodiment is the same as that of the first embodiment described above except that a mounting method of the circuit element 5 is different. In the following description, the present embodiment will be described with a focus on differences from the first embodiment described above, and the description of the same matters will be omitted. In addition, in each of the drawings of the present embodiment, the same components as those of the embodiments described above are denoted by the same reference numerals.

In the first embodiment described above, the circuit element 5 is bonded to the bottom surface 712 in a posture in which the active surface 50 faces upward, but in the present embodiment, as illustrated in FIGS. 11 and 12, the circuit element 5 is mounted on the bottom surface 712 by flip chip bonding (FCB) in a posture in which the active surface 50 faces downward. The plurality of first internal terminals 741 is disposed on the bottom surface 712, and the connection terminals P4 of the circuit element 5 are electrically connected to the corresponding first internal terminals 741 via conductive bonding members B3 such as gold balls. According to such a configuration, since the first stepped surface 713 can be omitted, the impact logger 1 can be reduced in size.

Even in the fourth embodiment described above, the same effects as those of the first embodiment described above can be exhibited.

### Fifth Embodiment

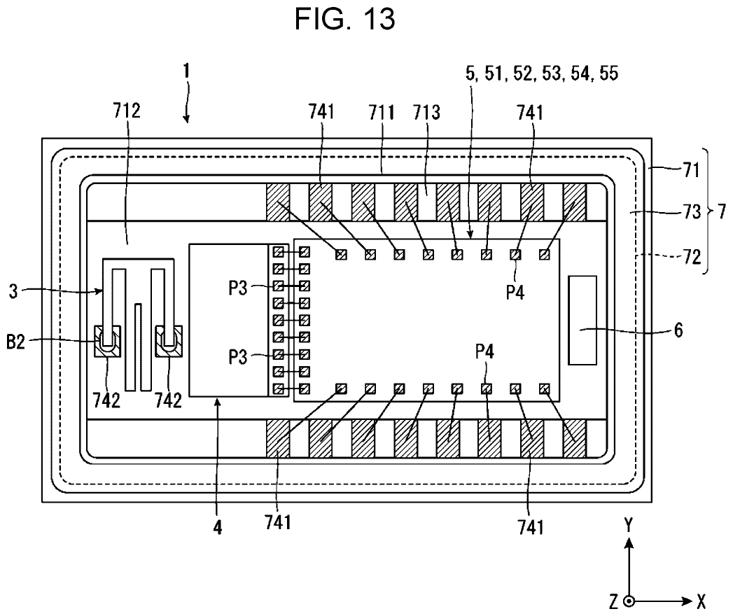

FIG. 13 is a top view of an impact logger according to a fifth embodiment.

The impact logger 1 of the present embodiment is the same as that of the above-described first embodiment except that the arrangement of each portion in the package 7 is different. In the following description, the present embodiment will be described with a focus on differences from the first embodiment described above, and the description of the same matters will be omitted. In addition, in each of the drawings of the present embodiment, the same components as those of the embodiments described above are denoted by the same reference numerals.

As illustrated in FIG. 13, in the impact logger 1 of the present embodiment, the support substrate 2 is omitted, and the vibration element 3, the acceleration sensor 4, the circuit element 5, and the battery 6 are disposed on the bottom surface 712 of the recessed portion 711. That is, in the impact logger 1 of the present embodiment, the vibration element 3, the acceleration sensor 4, the circuit element 5, and the battery 6 are arranged in a planar manner without overlapping with each other. According to such a configuration, for example, compared to the first embodiment described above, it is possible to suppress the thickness in the Z-axis direction to be small while the spread in an X-Y plane direction is increased.

Therefore, the impact logger 1 is suitable for an environment in which thinness is prioritized over smallness of the footprint. In the present embodiment, the second stepped surface 714 is omitted from the base 71, and the second internal terminals 742 for the vibration element 3 are disposed on the bottom surface 712 of the recessed portion 711.

Even in the fifth embodiment described above, the same effects as those of the first embodiment described above can be exhibited. However, the configuration of the impact logger 1 is not particularly limited, and for example, the circuit element 5 and the acceleration sensor 4 may be stacked to form the stacked body H in combination with the above-described embodiments. Further, the base 71 may have the recessed portion 719, and the battery 6 may be disposed on the bottom surface of the recessed portion 719.

### Sixth Embodiment

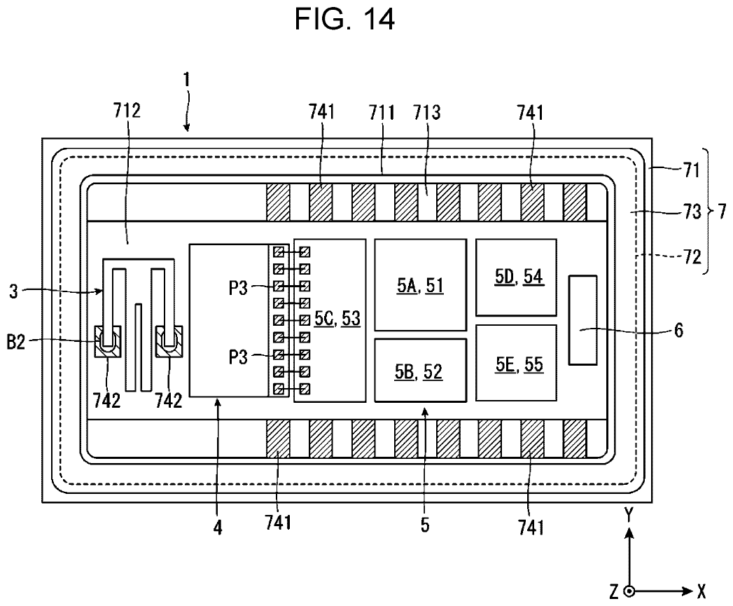

FIG. 14 is a top view of an impact logger according to a sixth embodiment. In FIG. 14, for convenience of description, illustration of members unnecessary for description, such as the connection terminals P3 and the wires W, is omitted.

The impact logger 1 of the present embodiment is the same as that of the fifth embodiment described above except that the configuration of the circuit element 5 is different. In the following description, the present embodiment will be described with a focus on differences from the first embodiment described above, and the description of the same matters will be omitted. In addition, in each of the drawings of the present embodiment, the same components as those of the embodiments described above are denoted by the same reference numerals.

In the fifth embodiment described above, the circuit element 5 is constituted by one chip, but in the present embodiment, the circuit element 5 is constituted by a plurality of chips. Specifically, as illustrated in FIG. 14, the circuit element 5 is divided into a first circuit element 5A in which the oscillation circuit 51 and a control circuit (not illustrated) are formed, a second circuit element 5B in which the clocking circuit 52 is formed, a third circuit element 5C in which the sensor circuit 53 is formed, a fourth circuit element 5D in which the memory circuit 54 is formed, and a fifth circuit element 5E in which the interface circuit 55 is formed. In this manner, by configuring the circuit element 5 with a plurality of chips, the degree of freedom of the arrangement of the circuit element 5 increases.

Even in the sixth embodiment described above, the same effects as those of the fifth embodiment described above can be exhibited. However, the configuration of the impact logger 1 is not particularly limited, and for example, the circuit element 5 may be configured to be divided into two to four or six or more chips. In addition, one or more circuits included in each circuit element can be arbitrarily combined.

### Seventh Embodiment

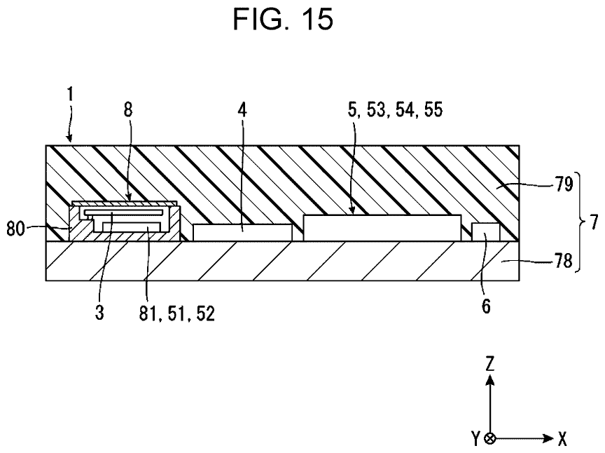

FIG. 15 is a sectional view of an impact logger according to a seventh embodiment.

The impact logger 1 of the present embodiment is the same as that of the fifth embodiment described above except that the configurations of the real-time clock and the package 7 are different. In the following description, the present embodiment will be described with a focus on differences from the first embodiment described above, and the description of the same matters will be omitted. In addition, in each of the drawings of the present embodiment, the same components as those of the embodiments described above are denoted by the same reference numerals.

In the impact logger 1 of the present embodiment, the package 7 includes a plate-shaped base 78 and a mold portion 79 that seals each portion disposed on the base 78 by molding. According to such a configuration, the package 7 is simplified.

The base 78 has a plate shape and is formed of, for example, a ceramic, a flexible printed circuit (FPC), or the like. A vibrator 8, the acceleration sensor 4, the circuit element 5, and the battery 6 are disposed on an upper surface of the base 78. Here, the vibrator 8 is the real-time clock RTC and includes a package 80, and the vibration element 3 and a circuit element 81 accommodated in the package 80. In addition, the oscillation circuit 51 and the clocking circuit 52 are formed in the circuit element 81. Therefore, the remaining sensor circuit 53, memory circuit 54, interface circuit 55, control circuit (not illustrated), and the like are formed in the circuit element 5. When the vibration element 3 is exposed in the package 7 as in the above-described first embodiment, the vibration element 3 cannot be molded. However, when the vibration element 3 is accommodated in the package 80 as in the present embodiment, a configuration in which the vibration element 3 can be molded is obtained.

The mold portion 79 seals the vibrator 8, the acceleration sensor 4, and the circuit element 5 to protect them from moisture, dust, impact, and the like. The molding material constituting the mold portion 79 is not particularly limited, and for example, a thermosetting epoxy resin or other curable resin materials can be used. The mold portion 79 can be formed by, for example, a transfer molding method or the like.

According to such a configuration, since the package 7 has a solid structure, it is possible to further increase the inherent vibration frequency of the impact logger 1. Therefore, it is possible to further effectively suppress the resonance with the impact during transportation, and it is possible to further accurately detect the impact.

As described above, in the impact logger 1 of the present embodiment, the package 7 includes the mold portion 79 that seals the circuit element 5 and the acceleration sensor 4. According to such a configuration, the package 7 is simplified. In addition, since the package 7 has a solid structure, the inherent vibration frequency of the impact logger 1 can be further increased. Therefore, the resonance with the impact during transportation can be further effectively suppressed, and the impact can be further accurately detected.

Even in the seventh embodiment described above, the same effects as those of the fifth embodiment described above can be exhibited.

Although the impact logger of the present disclosure has been described based on the illustrated embodiments, the present disclosure is not limited thereto. A configuration of each portion can be replaced with another configuration having a substantially equivalent function. In addition, any other configurations may be added to the present disclosure. For example, when power can be supplied from the outside, the battery 6 may be omitted.

What is claimed is:

1. An impact logger comprising:
an acceleration sensor;
a circuit element including a clocking circuit that generates time data, a sensor circuit that processes an output signal of the acceleration sensor, and a memory circuit that stores processing data processed by the sensor circuit and the time data in association with each other; and
a package that accommodates the acceleration sensor and the circuit element, wherein
the impact logger has a mass of less than 20 g.

2. The impact logger according to claim 1, wherein the mass is less than 10 g.

3. The impact logger according to claim 2, wherein the mass is less than 1 g.

4. The impact logger according to claim 1, wherein
when a mass of an impact measurement target is m1 and the mass is m2,
a relationship of m2≤( 1/50)×m1 is satisfied.

5. The impact logger according to claim 1, further comprising:
a battery that supplies power to the circuit element.

6. The impact logger according to claim 5, wherein
the battery is exposed to an outside of the package.

7. The impact logger according to claim 1, further comprising:
a vibration element accommodated in the package, wherein
the circuit element includes an oscillation circuit that oscillates the vibration element, and
when the oscillation circuit oscillates the vibration element to generate a clock signal, and the clocking circuit performs clocking based on the clock signal to generate the time data, a real-time clock is configured.

8. The impact logger according to claim 1, wherein
the package includes a base on which the acceleration sensor and the circuit element are disposed, and
the acceleration sensor and the circuit element are disposed on the base in a stacked state.

9. The impact logger according to claim 8, wherein
the circuit element is disposed on the base, and
the acceleration sensor is disposed on the circuit element.

10. The impact logger according to claim 8, wherein
the acceleration sensor is disposed on the base, and
the circuit element is disposed on the acceleration sensor.

11. The impact logger according to claim 8, wherein
the package includes a lid that is bonded to the base and accommodates the circuit element and the acceleration sensor between the lid and the base.

12. The impact logger according to claim 8, wherein
the package includes a mold portion that seals the circuit element and the acceleration sensor.

13. The impact logger according to claim 1, wherein
the circuit element includes a temperature sensor circuit that detects a temperature, and
the memory circuit stores temperature data detected by the temperature sensor circuit, the processing data, and the time data in association with each other.
